(19) United States
(12) Patent Application Publication
(10) Pub. No.: US 2021/0165306 A1
(43) Pub. Date: Jun. 3, 2021

(54) HANDHELD APPARATUS AND PHOTOGRAPHING DEVICE

(71) Applicant: SZ DJI TECHNOLOGY CO., LTD., Shenzhen (CN)

(72) Inventor: Shengjia GUO, Shenzhen (CN)

(21) Appl. No.: 17/174,318

(22) Filed: Feb. 11, 2021

Related U.S. Application Data
(63) Continuation of application No. PCT/CN2018/102454, filed on Aug. 27, 2018.

(51) Int. Cl. G03B 17/56; H04M 1/04; F16M 13/04; F16M 11/28

(52) U.S. Cl. CPC G03B 17/561; F16M 11/28; F16M 13/04; H04M 1/04

(57) ABSTRACT

A handheld apparatus includes a telescopic rod, a fixing frame mounted at a top end of the telescopic rod and configured to support a mobile electronic device, a handheld member sleeved at a position close to a bottom end of the telescopic rod that is configured to move between a first position and a second position relative to the handheld member, and a support structure foldably mounted at a bottom end of the handheld member and configured to be in a folded state to accommodate the bottom end of the telescopic rod when the telescopic rod is in the first position.

### CROSS-REFERENCE TO RELATED APPLICATION

This application is a continuation of International Application No. PCT/CN2018/102454, filed Aug. 27, 2018, the entire content of which is incorporated herein by reference.

### TECHNICAL FIELD

The present disclosure relates to the technical field of image and video photographing devices and, more particularly, to a handheld apparatus and a photographing device, which are applicable to various mobile phones or cameras.

### BACKGROUND

With the appearance of mobile electronic devices including mobile phones and tablets and the improvement of the performance of cameras mounted at these mobile electronic devices, more and more people give up using bulky professional cameras for photographing and instead use the above mobile electronic devices to take photos or videos in daily life or work scenes.

In general, when a mobile electronic device such as a mobile phone is used for photographing, the mobile electronic device is usually held by a user, and the length of the user's arm is limited, resulting in a short distance between a subject to be photographed and a lens of the mobile electronic device. Correspondingly, when one person or multiple people take a selfie, the selfie may become a big-head shot or some people may not be included in the picture.

Because of the above problem, a selfie stick that is configured to support a mobile electronic device for photographing is provided in existing technologies. When using the selfie stick, it is only necessary to clamp the mobile electronic device on the selfie stick through clamping arms of the selfie stick, and adjust the length of holding the selfie stick as needed, to achieve photographing requirements at a different distance. However, an existing selfie stick generally only has a fixed length, or only a part of a hollow rod can be extended or retracted to adjust the viewing distance. It is difficult to make full use of the length of the hollow rod to realize the user's demand for viewing at a larger distance.

### SUMMARY

In accordance with the disclosure, there is provided a handheld apparatus including a telescopic rod, a fixing frame mounted at a top end of the telescopic rod and configured to support a mobile electronic device, a handheld member sleeved at a position close to a bottom end of the telescopic rod that is configured to move between a first position and a second position relative to the handheld member, and a support structure foldably mounted at a bottom end of the handheld member and configured to be in a folded state to accommodate the bottom end of the telescopic rod when the telescopic rod is in the first position.

Also in accordance with the disclosure, there is provided a photographing device including a mobile electronic device and a handheld apparatus. The handheld apparatus includes a telescopic rod, a fixing frame mounted at a top end of the telescopic rod and configured to support the mobile electronic device, a handheld member sleeved at a position close to a bottom end of the telescopic rod that is configured to move between a first position and a second position relative to the handheld member, and a support structure foldably mounted at a bottom end of the handheld member and configured to be in a folded state to accommodate the bottom end of the telescopic rod when the telescopic rod is in the first position.

### BRIEF DESCRIPTION OF THE DRAWINGS

To explain the technical solutions of the embodiments of the present disclosure more clearly, the following will briefly introduce the drawings that need to be used in the description of the embodiments or the prior art. Obviously, the drawings in the following description are only some of the embodiments of the present disclosure. For those of ordinary skill in the art, without creative work, other drawings may be obtained from these drawings.

FIG. 1 illustrates an exemplary photographing device consistent with various embodiments of the present disclosure.

FIG. 2 is a schematic structural diagram of an exemplary handheld apparatus shown in FIG. 1 in a retraction state.

FIG. 3 is a front view of the handheld apparatus shown in FIG. 2.

FIG. 4 is a schematic structural diagram of the handheld apparatus shown in FIG. 1 in an extension state.

FIG. 5 is a front view of the handheld apparatus in FIG. 4.

FIG. 6 is an enlarged view of part A in FIG. 5.

FIG. 7 is a cross-sectional view of the handheld apparatus shown in FIG. 4 when a support structure of the handheld apparatus is in a folded state.

FIG. 8 is an enlarged view of part B in FIG. 7.

FIG. 9 is an enlarged view of part C in FIG. 7.

FIG. 10 is a partial enlarged view of FIG. 9.

FIG. 11 is a cross-sectional view of the handheld apparatus shown in FIG. 4 when the support structure is in an extended state.

FIG. 12 is an enlarged view of part D in FIG. 11.

FIG. 13 is a partial enlarged view of FIG. 12.

FIG. 14 is a schematic partial structural diagram of an exemplary fixing frame of the handheld apparatus shown in FIG. 1 consistent with various embodiments of the present disclosure.

FIG. 15 is a front view of an exemplary handheld gimbal shown in FIG. 1 consistent with various embodiments of the present disclosure.

FIG. 16 is a schematic partial structural diagram of a main body of the handheld gimbal shown in FIG. 1 consistent with various embodiments of the present disclosure.

FIG. 17 is a schematic partial structural diagram of another exemplary fixing frame of the handheld apparatus consistent with various embodiments of the present disclosure.

FIG. 18 is an explosive view of the fixing frame shown in FIG. 17.

FIG. 19 is a schematic structural diagram a connection device shown in FIG. 17 from one viewing angle consistent with various embodiments of the present disclosure.

FIG. 20 is a schematic structural diagram of the connection device from another viewing angle.

FIG. 21 is a left view of the connection device.

FIG. 22 is a partial top view of a main body of the fixing frame shown in FIG. 17 consistent with various embodiments of the present disclosure.

FIG. 23 is a partial left view of the main body.

FIG. 24 is a partial cross-sectional view of another exemplary main body consistent with various embodiments of the present disclosure.

### REFERENCE NUMERALS

1—handheld apparatus; 110—fixing frame; 1101—first buckle member; 1102—second buckle member; 11021—convex platform; 11021a—secondary detection contact; 11021b—secondary connection contact; 11021c—positioning groove; 11021d—protrusion; 1103—opening; 1104—lug; 11041—bearing hole; 1105—damping shaft; 200—telescopic rod; 2101—groove; 21011—top surface; 21012—bottom surface; 2102—bottom cover; 2103—friction surface; 300—communication wire; 400—handheld member; 4101—protrusion block; 4102—friction plate; 4103—limit surface; 500—controller; 600—support structure; 6101—leg; 61011—recessed part; 9—handheld gimbal camera; 901—main body; 9011—display screen; 9012—mounting slot; 90121—primary detection contacts; 90122—primary connection contact; 90123—retractable positioning block; 90124—sliding groove; 9013—control knob; 902—gimbal; 120—fixing frame; 121—connection device; 1211—housing; 12111—front wall; 12112—rear wall; 12113—side wall; 12113a—upper side wall; 12113b—lower side wall; 12113c—right side wall; 12113d—left side wall; 1212—connector; 1213—secondary connection contact; 1214—secondary detection area; 1215—protrusion; 1216—positioning groove; 122—main body; 1221—escape hole; 123—mounting groove; 123a—upper opening; 123b—lower surface; 123c—right side; 123d—left side; 123e—front opening; 123f—upper side; 1231—first receiving groove; 1232—second receiving groove; 1233—primary connection contact; 1234—primary detection contact; 1235—sliding groove; 1236—retractable positioning block.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure. Example embodiments will be described with reference to the accompanying drawings, in which the same numbers refer to the same or similar elements unless otherwise specified. When there is no conflict, different embodiments and/or features of embodiments can be combined.

In the description of this disclosure, the orientational or positional relationship indicated by “center,” “length,” “width,” “thickness,” “upper,” “lower,” “left,” “right,” “bottom,” “inner,” or “outer” refers to the orientational or positional relationship shown in the drawings. These terms are only for the convenience of describing the disclosure and simplifying the description, and do not indicate or imply that the apparatuses or elements referred to must have a specific position or orientation. Therefore, they do not limit the scope of the present disclosure.

In addition, the terms “first” and “second” are only used for descriptive purposes and should not be understood as indicating or implying relative importance or implicitly indicating the number of indicated technical features. Therefore, a feature associated with “first” and “second” may explicitly or implicitly include one or more of the feature. In the description of this disclosure, “multiple” or “plurality of” means two or more than two, such as two or three, unless otherwise specifically defined.

In the description of this disclosure, the terms “installation,” “mounting,” “connection,” and “fixing” should be interpreted broadly unless otherwise clearly specified and limited. For example, a connection may be a fixed connection or a detachable connection, or may refer to a body integrated as a whole. A connection may be a mechanical connection, or electrical connection or may refer to a communication between two bodies. A connection may be a direct connection, or an indirect connection via an intermediate medium. A connection may refer to the communication of insides of two components or the interaction of two components. For those of ordinary skill in the art, the specific meanings of the above terms in this disclosure may be understood according to specific circumstances.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

In this disclosure, descriptions with reference to term “one embodiment”, “some embodiments,” “examples,” “specific examples,” or “some examples” mean specific features, structures, materials, or characteristics described in conjunction with the embodiment or example are included in at least one embodiment or example of the present disclosure. In this disclosure, the schematic representations of the above terms do not necessarily refer to the same embodiment or example. Moreover, the described specific features, structures, materials, or characteristics can be combined in any one or more embodiments or examples in a suitable manner. In addition, when no conflict exits, those skilled in the art can combine different embodiments or examples and features of different embodiments or examples described in this disclosure.

Different embodiments or examples are used to described different structures consistent with the present disclosure below. To simplify the description of the embodiments, components, and settings of specific examples are described below. They are only examples and are not intended to limit the disclosure. In addition, reference numerals and/or reference letters may be repeated in different examples for the purpose of simplification and clarity, and not to indicate the relationship between the various embodiments and/or settings described. In addition, the present disclosure provides examples of various specific processes and materials, but those of ordinary skill in the art may be aware of the use of other processes and/or materials.

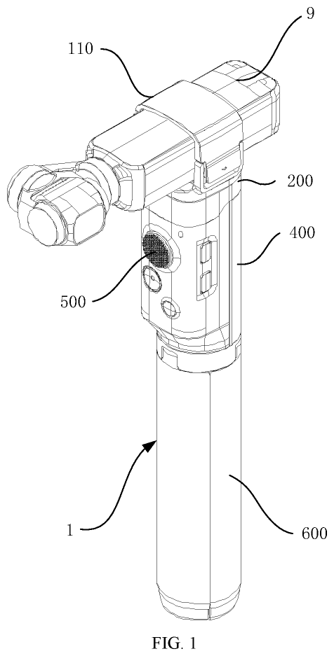

FIG. 1 shows a photographing device consistent with the disclosure. As shown in FIG. 1, the photographing device includes a mobile electronic device and a handheld apparatus 1 for holding the mobile electronic device.

In various embodiments, specifically, the mobile electronic device may be any suitable electronic device including a mobile phone, a tablet, a camera, or a handheld gimbal camera. For example, in some embodiments, the mobile electronic device may be a handheld gimbal camera 9 and a camera may be mounted at the handheld gimbal camera 9.

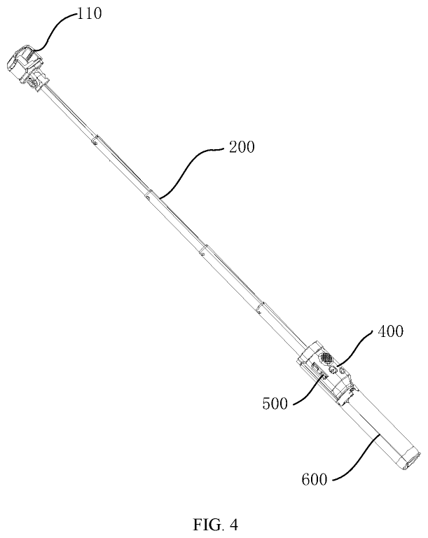

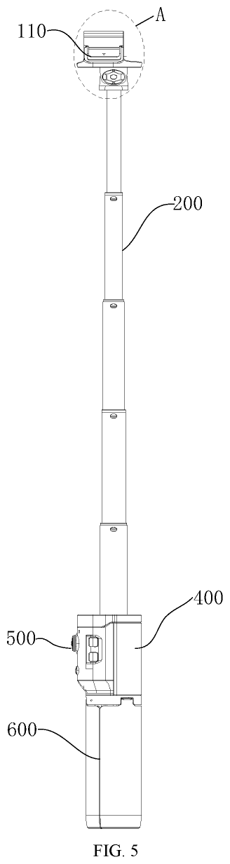

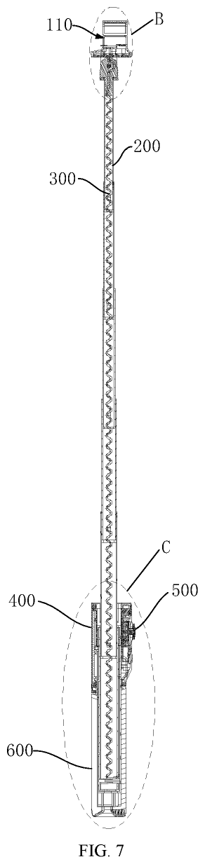

As shown in FIG. 1, the handheld apparatus 1 includes: a fixing frame 110, a telescopic rod 200, a handheld member 400, and a support structure 600. The fixing frame 110 is mounted at a top end of the telescopic rod 200, for supporting the mobile electronic device. As shown in FIG. 4 and FIG. 1, the handheld member 400 is sleeved at a position close to a bottom end of the telescopic rod 200, such that the bottom end of the telescopic rod 200 can move between a first position and a second position along an axis of the telescopic rod 200 and relative to the handheld member 400. The support structure 600 is foldably mounted at a bottom end of the handheld member 400. Further, as shown in FIG. 5 and FIG. 7, when the telescopic rod 200 is in the first position, is able to be in a folded state such that the bottom end of the telescopic rod 200 can be accommodated in the support structure 600. The support structure 600 can be, e.g., a tripod.

In various embodiments, the fixing frame 110 may be a gimbal, or another suitable supporting structure including a supporting rod, a supporting block, a supporting platform, or a supporting frame. In some embodiments where the fixing frame 110 is not a gimbal, a gimbal may be mounted at the supporting structure that is not a gimbal and the mobile electronic device may be mounted at the gimbal to improve stability of the mobile electronic device. In some other embodiments, the mobile electronic device may be mounted at the supporting structure directly. For example, in various embodiments, the fixing frame 110 may be a single-axis gimbal, a dual-axis gimbal, or a three-axis gimbal suitable for holding the mobile electronic device including a camera or a mobile phone, or a clamping device.

In some embodiments, the fixing frame 110 may be mounted at the top end of the telescopic rod 200. For example, a motor base of the three-axis stabilization gimbal for mounting a yaw axis may be fixed at the top end of the telescopic rod 200. In some other embodiments, it is also possible to fix a supporting block or a supporting frame at the top end of the telescopic rod 200 as the fixing frame 110.

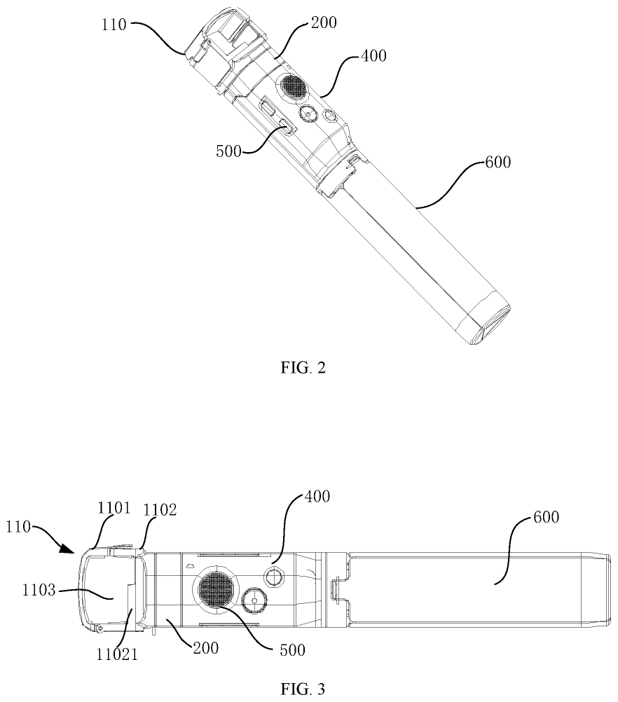

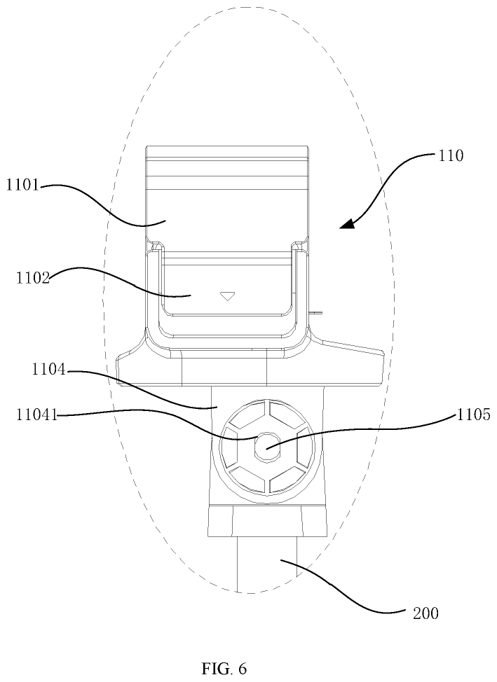

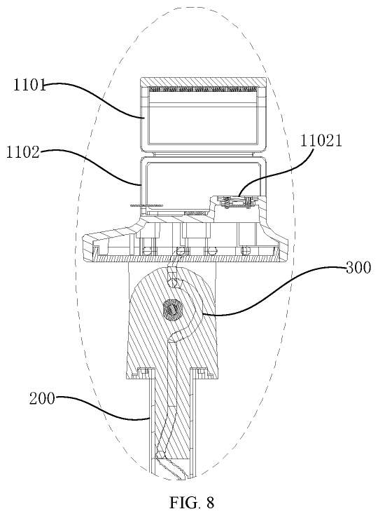

In some embodiments, as shown in FIG. 6 and FIG. 8, the fixing frame is rotatably connected to the top end of the telescopic rod 200. The fixing frame 110 may be a supporting platform or another similar structure, such as a structure including a first buckle member 1101 and a second buckle member 1102, as shown in FIG. 2 and FIG. 3. The first buckle member 1101 and the second buckle member 1102 may be detachably buckled together to form an opening 1103 where the mobile electronic device may pass, such that the mobile electronic device may be mounted. The second buckle member 1102 may be rotatably connected to the top end of the telescopic rod 200. In some other embodiments, the opening 1103 may be formed at the supporting block, the supporting platform, or other structure connected to the top end of the telescopic rod 200, to achieve mounting of the mobile electronic device. In some embodiments, the fixing frame 110 may be a frame structure rotatably connected to the top end of the telescopic rod 200.

Optionally, an electrical connection mechanism may be formed at an inner wall of the opening 1103 formed in the fixing frame 110 (or in another part of the fixing frame 110), and the mobile electronic device may include an electrical connection structure that cooperates with the electrical connection mechanism. The electrical connection mechanism and the electrical connection structure may be mated together to achieve electrical connection (including at least one of a power supply connection or a communication connection) between the handheld apparatus 1 and the mobile electronic device. For example, the electrical connection mechanism formed at the fixing frame 110 may be a connector of any form, e.g., a wired connector for charging the mobile electronic device, such that the connector may be mated with the interface of the mobile electronic device to realize charging between the handheld apparatus and the mobile electronic device. In some other examples, the electrical connection mechanism may also have other structural forms, including the connector described below or the secondary connection contact.

In some embodiments, as shown in FIG. 6 and FIG. 8, the fixing frame 110 is rotatably connected to the top end of the telescopic rod 200 through a damping shaft 1105, such that the fixing frame 110 may be self-locked when the fixing frame 110 rotates to any position relative to the telescopic rod 200. The stability and safety of the mobile electronic device mounted at the fixing frame 110 may be improved. Further, the fixing frame may be rotated 360 degrees via adjustment of the damping shaft 1105, and the angle of the fixing frame 110 may be adjusted freely during use to achieve the purpose of adjusting the orientation of the mobile electronic device. In some other embodiments, the fixing frame 110 may be connected to the telescopic rod 200 rotatably by hinge connection or other means.

In some embodiments, to realize the rotational connection between the fixing frame 110 and the top end of the telescopic rod 200, two opposite lugs 1104 may be formed at the fixing frame 110, and the two lugs 1104 may be provided with bearing holes 11041. Therefore, the damping shaft 1105 may pass through the top end of the telescopic rod 200 and be supported by the bearing holes 11041 of the two lugs 1104.

Optionally, the above damping shaft 1105 may include a polygonal shaft, and the bearing holes 11041 formed in the lug 1104 may include polygonal holes matching the shape of the polygonal shaft, such as regular hexagon holes. Correspondingly, shape matching between the shaft and bearing holes 11041 may realize the restriction on the rotation angle of the fixing frame 110.

As shown in FIG. 4 and FIG. 5, the telescopic rod 200 includes a plurality of rods with small to large inner diameters sleeved one over another. The rod with the smallest inner diameter is used to hold the fixing frame 110, and the handheld member 400 is sleeved over the rod with the largest inner diameter at a position close to an end of the rod. As such, the telescopic function of the telescopic rod 200 can be realized, and the bottom end of the telescopic rod 200 may move between the first position and the second position relative to the handheld member 400 along the axis of the telescopic rod 200. In another embodiment, some parts of the rod are made to have a continuously folding structure to realize the telescopic rod.

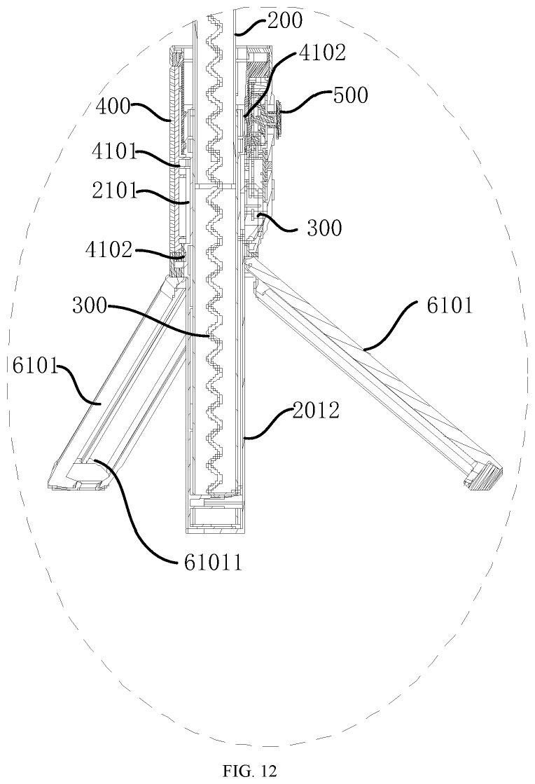

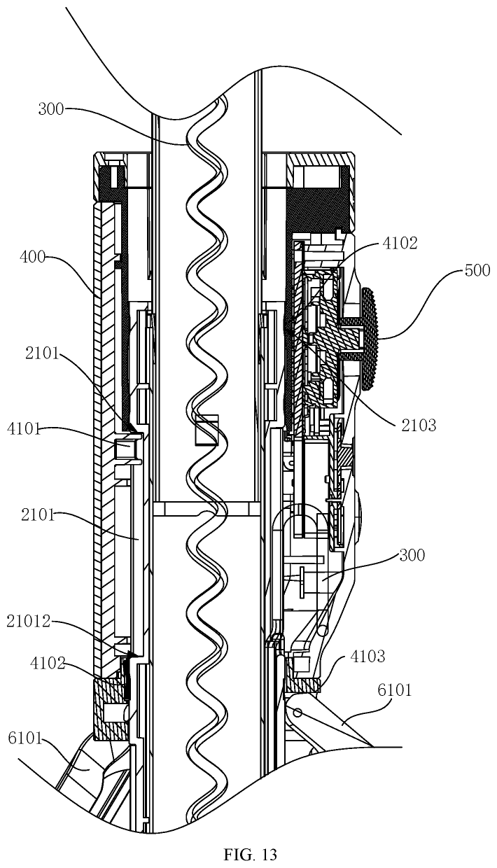

To realize the communication connection between the mobile electronic device and the handheld member 400, as shown in FIG. 12 and FIG. 13, in some embodiments, a communication wire 300 is inserted into the telescopic rod 200. A first end of the communication wire 300 extends out of the telescopic rod 200 and into the handheld member 400 to be electrically connected to the controller 500 disposed at the handheld member 400. As shown in FIG. 8, a second end of the communication wire 300 extends out of the telescopic rod 200 and into the above fixing frame 110 to be connected to the mobile electronic device mounted at the fixing frame 110. In order to adapt to the movement of the bottom end of the telescopic rod 200 between the first position and the second position relative to the handheld member 400, a length of the communication wire 300 extending into the handheld member 400 is reserved with sufficient length variation margin such that the communication wire 300 may extend or bend to adapt to the above position changes. In some other embodiments, to avoid wiring problem, the communication wire 300 may be omitted, and the communication between the handheld member 400 and the mobile electronic device may be established via a wireless connection (including but not limited to WIFI, ZigBee, Bluetooth, infrared, etc.). In some other embodiments, the communication wire 300 may be disposed outside the telescopic pole 200.

Since the telescopic rod 200 needs to be extended or shortened during use, the communication wire 300 disposed in the telescopic rod 200 may have a reserved length so that it may stretch or bend as the telescopic rod 200 is extended or shortened. For example, a part of the communication wire 300 located in the telescopic rod 200 may have a spiral shape. The possibility of the communication wire 300 being broken due to repeated folding of the same part may be reduced.

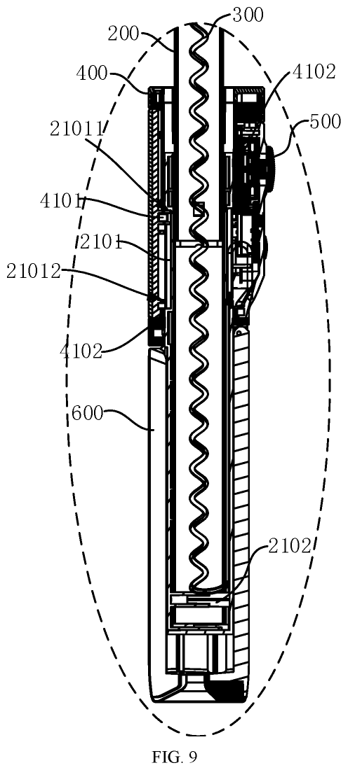

In some embodiments of the present disclosure, as shown in FIG. 9, the first end of the communication wire 300 extends out of the telescopic rod 200 and into the handheld member 400 to be electrically connected to the controller 500 disposed at the handheld member 400. As shown in FIG. 8, the second end of the communication wire 300 extends out of the telescopic rod 200 and into the above fixing frame 110 to be connected to the mobile electronic device mounted at the fixing frame 110. Two ends of the communication wire 300 penetrate openings at two ends of the telescopic rod 200 respectively, such that other modification on the telescopic rod 200 may be avoided. Process of production and cost may be reduced, and the strength of the telescopic rod 200 may not be affected.

In some embodiments, a bottom cover 2102 is sleeved at the bottom end of the telescopic rod 200. After passing through the opening at the bottom end of the telescopic rod 200, the first end of the communication wire 300 may first pass through a gap between the bottom cover 2102 and the telescopic rod 200, and then extend into the handheld member 400. With the bottom cover 2102 provided, when the bottom end of the telescopic rod 200 is in the first position, the top end of the bottom cover 2102 may be covered by the handheld member 400 to prevent the communication wire 300 from being exposed to the external air environment to maintain the overall aesthetics and reduce the possibility of damage to the communication wire 300.

In some other embodiments, the first end of the communication wire 300 may not pass through the opening at the bottom end of the telescopic rod 200. Instead, near the bottom end of the telescopic rod 200 (for example, at a first predetermined distance from an edge of the bottom end), a first wire-passing hole may be formed, such that the first end of the communication wire 300 may pass through the first wire-passing hole and then extend into the handheld member 400. To prevent the first cable hole from being seen by the user and improve the overall aesthetics, the first wire-passing hole may be configured to be blocked by the handheld member 400 when the bottom end of the telescopic rod 200 is in the second position and to be blocked by the folded support structure 600 when the bottom end of the telescopic rod 200 is in the first position.

Similar to the first end of the communication wire 300, in some embodiments, the second end of the communication wire 300 may not pass through the top end of the telescopic rod 200, but instead a second wire-passing hole may be formed near the top end of the telescopic rod 200 (that is, at a position at a predetermined distance from an edge of the top end), such that the second end of the communication wire 300 may pass through the second wire-passing hole and extend into the fixing frame 110. Correspondingly, the communication wire 300 may be connected to the mobile electronic device disposed at the fixing frame 100 conveniently.

To realize the electrical connection between the second end of the communication wire 300 extending into the fixed frame 110 and the movable electronic device, the above electrical connection mechanism may be provided at the fixed frame 110 such that the electrical connection mechanism may be electrically connected to the movable electronic device and electrically connected to the second end of the communication wire 300. For example, when the movable electronic device is a mobile phone, a Micro-b connector electrically connected to the second end of the communication wire 300 may be mounted at the fixing frame 110. In use, the interface of the mobile phone is matched with the Micro-b connector of the fixing frame 110 to realize the communication connection and power supply connection between the mobile phone and the controller 500 located at the handheld member 400 described below. In various embodiments, the electrical connection mechanism may be any suitable plug type such as a USB connector, a Type-c connector, a Micro-b connector or a pin plug connector. In some embodiments, the electrical connection mechanism may also be a secondary connection contact that matches a primary connection contact of a mobile electronic device (such as a handheld gimbal). Optionally, the electrical connection mechanism may be formed at the inner wall of the opening 1103 of the fixing frame 110 for the movable electronic device to pass through, or may be formed at the top surface of the supporting platform-type fixing frame 110.

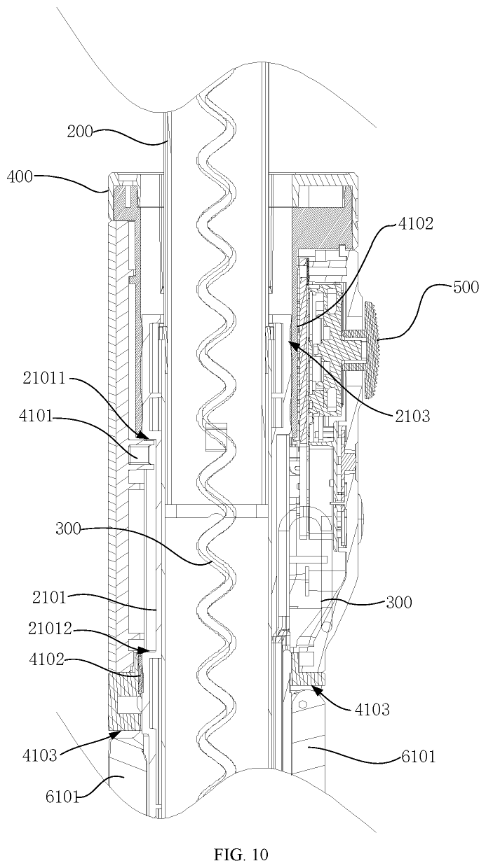

As shown in FIG. 9 and FIG. 10, in some embodiments, the handheld member 400 adopts a sleeve with openings at both ends to realize the function of the telescopic rod 200 being able to move relative to the handheld member 400. As shown in FIG. 2 to FIG. 5, the handheld member 400 is provided with a controller 500. The controller 500 may be provided with a joystick for controlling movement of a gimbal, or one or more control buttons (including but not limited to a camera button, a video button, a mode button, etc.) to control the mobile electronic device fixed at the fixing frame 110. In some embodiments, the controller 500 may also be provided with a functional interface, such as a charging port or a USB interface. The controller 500 may be in communication connection with the mobile electronic device mounted at the fixing frame 110, for example, through a wireless connection, the communication wire 300 running through the telescopic rod 200, or the communication wire 300 outside the telescopic pole 200, as mentioned above.

In some embodiments, to realize that the bottom end of the telescopic rod 200 may move between the first position and the second position relative to the handheld member 400, various structures including a thread structure or a spring structure may be adopted. Specifically, in some examples, internal threads may be formed at the inner wall of the handheld member 400 and external threads may be formed at the outer wall of the telescopic rod 200. Correspondingly, when the telescopic rod 200 is screwed, the bottom end of the telescopic rod 200 may move relative to the handheld member 400. In some other embodiments, an upper rib (or lower rib) may be formed at the inner wall of the handheld member 400, and a lower rib (or upper rib) may be formed at the outer wall of the telescopic rod 200. A spring may be disposed between the lower rib and the upper rid. Correspondingly, only an external force in the axial direction may need to be applied to the telescopic rod 200 to cause the spring to be compressed or stretched, thereby causing the telescopic rod 200 to move relative to the handheld member 400.

In some embodiments, to limit the position of the bottom end of the telescopic rod 200 when it moves relative to the handheld member 400, the telescopic rod 200 and the handheld member 400 may be provided with a first limit structure and parts of the first limit structure at the telescopic rod 200 and the handheld member 400 can cooperate with each other. With the first limit structure, the bottom end of the telescopic rod 200 may only move between the first position and the second position relative to the handheld member 400. As such, on the basis of the telescopic capability of the top of the telescopic end relative to the handheld member 400, a desired length variation range of the fixing frame 110 relative to the handheld member 400 may be achieved via specific design of the first limit structure to adjust the movement range of the bottom end of the telescopic rod 200. In some embodiments, the first position and the second position may be the upper and lower limit positions that allow the bottom end of the telescopic rod 200 to move respectively. For example, the first position may be the lower limit position of the bottom end of the telescopic rod 200, and the second position may be the upper limit position of the bottom end of the telescopic rod 200.

In some embodiments, the first limit structure may be a spring pin and a positioning hole that cooperate with each other. The spring pin may be provided at the telescopic rod 200, and the positioning hole may be opened on the inner wall of the handheld member 400. In some other embodiments, the first limit structure may be the length of the internal thread or the external thread in the threaded structure for realizing the relative movement of the telescopic rod 200 and the handheld member 400. In some other embodiments, the first limit structure may be an upper rib and a lower rib in a spring structure for realizing the relative movement of the telescopic rod 200 and the handheld member 400.

In some other embodiments as shown in FIG. 9, FIG. 10, FIG. 12, and FIG. 13, the first limit structure includes a groove 2101 and a protrusion block 4101 that cooperate with each other, to limit the position of the movement of the telescopic rod 200 relative to the handheld member 400. For example, in some embodiments, a groove may be provided at the handheld member 400, and a protrusion extending into the groove may be formed at the outer wall of the telescopic rod 200.

In some other embodiments, as shown in FIG. 10 and FIG. 13, an axial groove 2101 is provided at the telescopic rod 200, and a protrusion block 4101 extending into the axial groove 2101 may be formed at the inner wall of the handheld member 400. In some embodiments, one or more grooves 2101 may be provided at the telescopic rod 200 along the circumferential direction, and the grooves 2101 may be blind grooves or through grooves. Accordingly, one or more protrusion blocks 4101 extending into the axial grooves 2101 may be formed at the inner wall of the handheld member 400. The height of the protrusion blocks 4101 may be smaller than the height of the grooves 2101, such that the grooves 2101 may move up and down relative to the protrusion blocks 4101 to realize the movement of the bottom end of the telescopic rod 200 between the first position and the second position.

In some embodiments, the grooves 2101 may be annular. It may be understood that when the annular grooves 2101 are provided at the telescopic rod 200, the grooves 2101 are blind grooves. Correspondingly, when the grooves 2101 are annular, the protrusion blocks 4101 may also be annular to match the annular grooves 2101.

When the position of the bottom end of the telescopic rod 200 needs to be adjusted, for example, when the bottom end of the telescopic rod 200 needs to be moved from the first position to the second position, it may be only necessary to pull the telescopic rod 200 from the top end of the telescopic rod 200 or push the telescopic rod 200 from the bottom end of the telescopic rod 200 to move the protrusion blocks 4101 of the first limit structure to the top surface 21011 of the grooves 2101 of the first limit structure. When the bottom end of the telescopic rod 200 needs to be moved from the second position to the first position, it may be only necessary to push the top end of the telescopic rod 200 or pull the bottom end of the telescopic rod 200, such that the protrusion blocks 4101 of the first limit structure move toward the bottom surface 21012 of the grooves 2101 of the first limit structure.

Further, in some embodiments, the handheld member 400 and the telescopic rod 200 may be also provided with a lock structure including parts that cooperate with each other for locking the handheld member 400 and the telescopic rod 200 when the bottom end of the telescopic rod 200 moves to a predetermined position. For example, in some embodiments, a matching structure including a fixing pin and a fixing hole may be used as the locking structure to realize the locking function of the handheld member 400 and the telescopic rod 200. For example, a first positioning hole may be opened at the handheld member 400, and a plurality of second positioning holes may be opened at the telescopic rod 200. The first positioning hole at the handheld member 400 and the second positioning hole at the telescopic rod 200 may be aligned. When the bottom end of the telescopic rod 200 moves to the user's expected position (i.e., the predetermined position), the fixing pin may be passed through the first positioning hole and a second positioning hole aligned with it to lock the handheld member 400 and the telescopic rod 200.

As shown in FIG. 9, FIG. 10, FIG. 12 and FIG. 13, in some embodiments, a friction structure is be used to lock the handheld member 400 and the telescopic rod 200. Through the design of the frictional force of the friction structure, it may be realized that the telescopic rod 200 and the handheld member 400 may be self-locked at any position between the first position and the second position without external force, to improve stability and security performance of the handheld apparatus 1. For example, as shown in FIG. 10 and FIG. 13, the friction structure includes a friction plate 4102 provided at the inner wall of the handheld member 400, and the friction plate 4102 cooperates with a friction surface 2103 at the telescopic rod 200 to improve friction between the handheld member 400 and the telescopic rod 200, such that the self-locking function is achieved. In some other embodiments, the friction plate 4102 may also be arranged at the outer wall of the telescopic rod 200, and the inner wall of the handheld member 400 may be provided with a friction surface 2103 matching the friction plate 4102.

Optionally, the friction plate 4102 may be arranged at a position close to the first limit structure to avoid mutual influence between the friction plate 4102 and the first limit structure. Further, the friction plate 4102 may also be arranged separately, to facilitate the replacement of the friction plate 4102. For example, as shown in FIG. 10 and FIG. 13, the friction plate 4102 may include a first friction plate 4102 and a second friction plate 4102 respectively disposed at two ends of the first limit structure along the axial direction of the telescopic rod 200. By setting up the friction plates 4102 at two ends of the first limit structure, the area of the friction surface 2103 may be increased, and a better friction value may also be obtained to ensure a good locking effect. In addition, in some embodiments, the friction plate 4102 may be an annular friction plate 4102 to increase the circumferential friction force of the entire telescopic rod 200, thereby further improving the locking effect.

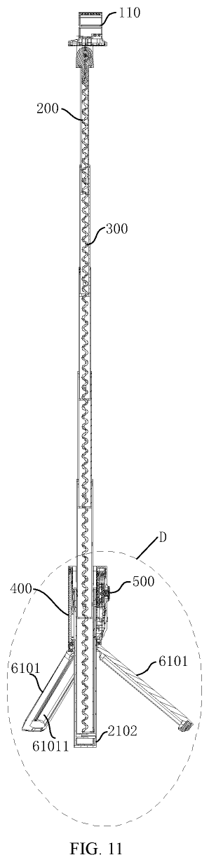

As shown in FIG. 2, in some embodiments, the support structure 600 is fixed at the bottom end of the handheld member 400. The support structure may transform freely between the folded state shown in FIG. 2 to FIG. 5, FIG. 7 and FIG. 9 and the extended state shown in FIG. 11 and FIG. 13. In the following, the matching relationship between the changes in the status of the support structure 600 and the position changes of the telescopic rod 200 is briefly described in connection with the drawings, to more clearly illustrate the matching relationship between the telescopic rod 200, the handheld member 400, and the support structure 600.

As shown in FIG. 4, FIG. 5, FIG. 7 and FIG. 9, when the telescopic rod 200 is in the first position, the support structure 600 is in a folded state to accommodate the bottom end of the telescopic rod 200 in the support structure 600. In another embodiment, when the telescopic rod 200 is in the first position, the support structure 600 may be in the extended state as shown in FIG. 11 and FIG. 13. When the telescopic rod 200 is in the second position, the support structure 600 may also be in the open state or the folded state. In general, when the support structure 600 is in the extended state, the bottom end of the telescopic rod 200 is usually moved to the second position.

When the telescopic rod 200 is in the first position, if the support structure 600 is in the folded state, the top end of the telescopic rod 200 may be directly pulled to move the bottom end of the telescopic rod 200 from the first position to the second position, and then whether to extend the support structure 600 may be determined according to the situation. In some other embodiments, the support structure 600 may be extended first, and then the bottom end of the telescopic rod 200 may be pushed or the top end of the telescopic rod 200 may be pulled to move the bottom end of the telescopic rod 200 from the first position to the second position. Subsequently, whether to fold the support structure 600 may be determined according to the situation. When the support structure 600 is in the extended state, either the top end of the telescopic rod 200 may be directly pulled or the bottom end of the telescopic rod 200 may be pushed directly, to move the bottom end of the telescopic rod 200 from the first position to the second position, and then whether to fold the support structure 600 may be determined according to the actual condition.

When the telescopic rod 200 is in the second position and the support structure 600 is in the folded state, the top end of the telescopic rod 200 may be directly pushed to move the bottom end of the telescopic rod 200 from the second position to the first position, and then whether to extend the support structure 600 may be determined according to the situation. In some other embodiments, the support structure 600 may be extended first, and then the bottom end of the telescopic rod 200 may be pulled or the top end of the telescopic rod 200 may be pushed to move the bottom end of the telescopic rod 200 from the second position to the first position. Subsequently, whether to fold the support structure 600 may be determined according to the situation. If the support structure 600 is in the extended state, either the top end of the telescopic rod 200 may be directly pushed or the bottom end of the telescopic rod 200 may be pulled directly, to move the bottom end of the telescopic rod 200 from the second position to the first position. Then whether to fold the support structure 600 may be determined according to the actual condition.

In various embodiments, when the telescopic rod 200 is in the second position, the bottom end of the telescopic rod 200 may be accommodated in the handheld member 400, or may be located outside the handheld member 400, which may be set by those skilled in the art according to actual needs.

As shown in FIG. 11 and FIG. 12, the support structure 600 generally includes a plurality of legs 6101. In some embodiments, the support structure 600 includes three legs 6101, and is called a tripod 600. In some embodiments, each leg 6101 is rotatably connected with the handheld member 400. Specifically, as shown in FIG. 13, each leg 6101 and the handheld member 400 are hinged together by a hinge shaft, such that each leg 6101 may rotate relative to the handheld member 400 around the hinge shaft to achieve free transformation between the extended state and folded state.

As shown in FIG. 13, to limit the opening angle of the leg 6101, a limit surface 4103 that cooperates with the plurality of legs 6101 is formed at the bottom end of the handheld member 400, such that the limit surface 4103 may block the plurality of legs 6101 when the legs 6101 are opened by a preset angle, to restrict the plurality of legs 6101 from further rotating. Correspondingly, the opening range of the support structure 600 is controlled by limiting the angle of rotation of the legs 6101. For example, the limit surface 4103 may be configured such that when the plurality of legs 6101 rotate to this position and abut against the limit surface 4103, the support formed by the plurality of legs 6101 may enable the telescopic rod 200 located at the center, the fixed frame 110 mounted at the top of the telescopic rod 200, and the mobile electronic equipment at the fixing frame 110 to stably stand on the ground or table to ensure safety.

As shown in FIG. 9 and FIG. 12, each leg 6101 is formed with a recessed part 61011. The recessed parts 61011 of the plurality of legs 6101 in the folded state enclose to form an accommodation cavity. When the bottom end of the telescopic rod 200 is located at the first position, the whole bottom end of the telescopic rod 200 may be accommodated in the accommodating cavity.

In the handheld apparatus 1 provided by various embodiments of the present disclosure, the bottom end of the telescopic rod 200 may move between the first position and the second position relative to the handheld member 400 sleeved near the bottom end of the telescopic rod 200 along the axis of the telescopic rod 200. Correspondingly, the flexibility of adjusting the length of the handheld apparatus 1 may be improved to meet the user's viewing requirements in a large range. Moreover, when the bottom end of the telescopic rod 200 is in the first position, the support structure 600 may wrap the bottom end of the telescopic rod 200 in the folded state, such that the support structure 600 may be used as a part of the user's grip. The length of the handheld member 400 may be reduced, thereby reducing the weight of the handheld member 400 in the handheld apparatus 1 and improving the convenience of use. When the telescopic rod 200 is in the second position, the support structure 600 not only can be configured in the folded state to facilitate the user to hold for handheld remote viewing, but also can be configured in the extended state to be mounted on a support such as the ground or a desktop for shooting.

Further, the handheld apparatus 1 provided by the present disclosure may make the distance between the fixing frame 110 and the handheld member 400 farther without increasing the length of the telescopic rod 200, such that more scene content may be captured when the user takes a selfie. For example, the user may capture a full-body portrait of the user, or capture more people in a group photo or more background content in the screen. When the user is photographing other objects, the camera may be made closer to the subject, to obtain clearer images. For example, it may be suitable for close photographing of distant objects such as plants outside the cliff or lotus on the lake or objects that are not suitable for close proximity.

In some embodiments, the long distance viewing may include not only the case where the user moves the camera away from the user when taking a selfie, but also the case where the user moves the camera closer to an object when shooting the object. When the user takes a selfie, since the camera needs to be kept farther away from the user, the distance between the handheld member 400 of the handheld apparatus 1 and the fixing frame 110 should be farther to meet the viewing requirements. When the user photographs other objects, the camera needs to be closer to the objects, and farther away from the user. Therefore, the distance between the handheld member 400 of the handheld apparatus 1 and the fixing frame 110 should also be larger to meet the viewing requirement.

The present disclosure provides a photographing device based on the previous embodiments. An electrical connection between a mobile electronic device of the photographing device and the fixing frame of the handheld apparatus may be achieved through contact points. The electrical connection mechanism between the mobile electronic device and the handheld apparatus can be simplified. The volume and weight of the photographing device can be reduced, and quick disassembly and assembly can be achieved.

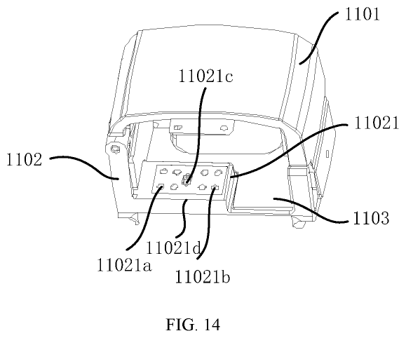

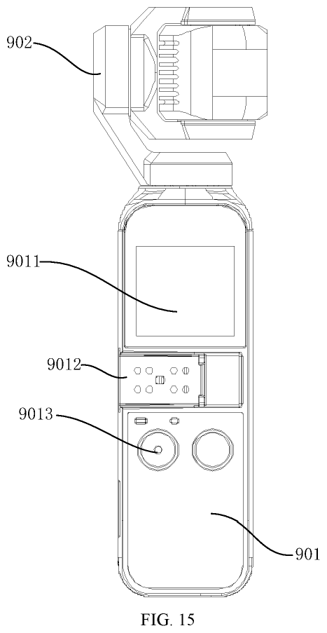

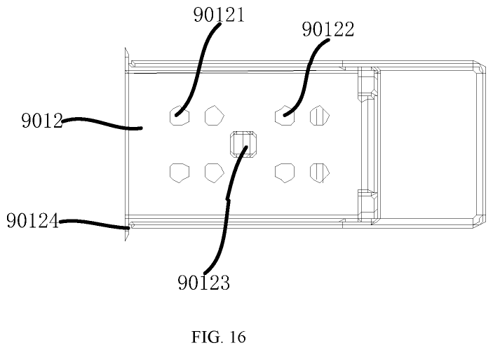

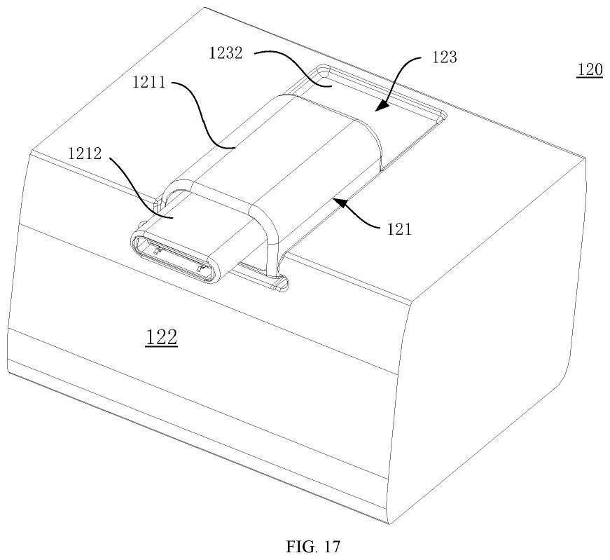

FIG. 14 is a schematic partial structural diagram of the fixing frame of the handheld apparatus shown in FIG. 1. FIG. 15 is a front view of the handheld gimbal shown in FIG. 1, and FIG. 16 is a schematic partial structural diagram of the main body shown in FIG. 15.

In some embodiments, as shown in FIG. 1 to FIG. 3, FIG. 8, and FIG. 14 to FIG. 16, the photographing device includes: the handheld apparatus 1 and a handheld gimbal camera 9 (or another mobile electronic device) detachably mounted at the fixing frame 110 of the handheld apparatus 1. In these embodiments, the structure of the handheld apparatus 1 except for the electrical connection mechanism is similar to the example embodiments described above, which can be referred to for details and will not be repeated here.

Specifically, as shown in FIG. 1 and FIG. 15, the handheld gimbal camera 9 includes: a main body 901 with a substantially rounded rectangular shape, and a gimbal camera 902 (such as a single-axis gimbal camera 902, a double-axis gimbal camera 902, or a three-axis gimbal camera 902) fixed at a top end of the main body 901. A camera or another electronic equipment with photographing function may be mounted at the gimbal camera 902. The main body 901 is provided with a display screen 9011, a mounting slot 9012, a control knob 9013, etc. The display screen 9011 may be used to observe the images captured by the camera in real time or display the functions of the handheld gimbal camera 9. The mounting slot 9012 is provided with an electrical connection mechanism for mating with an electrical connection mechanism provided at the handheld apparatus 1, to realize at least one of functions including power supply or signal transmission between the handheld gimbal camera 9 and the handheld apparatus 1. The control knob 9013 may be used to control operation of the handheld gimbal camera 9 or adjust the parameters of the handheld gimbal camera 9, etc. In some other embodiments, the main body 901 may also have any other suitable shape. In some embodiments, when the handheld gimbal camera 9 needs to be inserted into the opening 1103 of the fixing frame 110, the main body 901 may have a size and shape suitable for the opening 1103.

The mating part of the handheld gimbal camera 9 and the handheld apparatus 1 including the electrical connection mechanism, will be described in detail below for a clear understanding of the solution of this embodiment.

As shown in FIG. 14, in some embodiments, the fixing frame 110 includes a first buckle member 1101 and a second buckle member 1102. The first buckle member 1101 and the second buckle member 1102 are detachably buckled together to form an opening 1103 and the handheld gimbal camera 9 may pass through the opening 1103. A convex platform 11021 is formed at the inner wall of the second buckle member 1102. The convex platform 11021 is provided with a secondary connection contact 11021a to be electrically connected to a second end of the communication wire 300 passing through the fixing frame 110. The secondary connection contact 11021a is disposed at the convex platform 11021 and is electrically connected to the second end of the communication wire 300 extending into the fixing frame 110. In another embodiment, the fixing frame 110 may also be an integral block structure. The block structure may be provided with an opening 1103 and the handheld gimbal camera 9 can pass through the opening 1103. The convex platform 11021 may be disposed at the inner wall of the fixing frame 110, and provided with the secondary connection contact 11021a electrically connected to the second end of the communication wire 300. In some other embodiments, the fixing frame 110 may also be any other suitable structure with the opening 1103 formed thereon.

To mate with the above secondary connection contact 11021a, as shown in FIG. 15 and FIG. 16, the mounting slot 9012 opened at the main body 901 of the hand-held gimbal camera 9 is provided with a primary connection contact 90122 to be mated with the secondary connection contact 11021b. Correspondingly, when the portable electronic device including the handheld gimbal camera 9 passes through the opening 1103 at the fixed frame 110 of the handheld apparatus 1 and is detachably connected to the fixing frame 110, the convex platform 11021 in the fixed opening 1103 is partially accommodated in the mounting slot 9012 of the handheld gimbal camera 9, such that the primary connection contact 90122 and the secondary connection contact 11021b are in contact to achieve electrical connection. Correspondingly, electrical connection between the handheld gimbal camera 9 and the controller 500 of the handheld apparatus 1 is achieved.

In some embodiments, as showing in FIG. 14, the secondary connection contact 11021b may include a plurality of secondary connection contacts 11021b forming a circular or rectangular secondary connection contact array, to improve reliability of electrical connection between the primary connection contact 90122 and the secondary connection contacts 11021b. For example, in some embodiments in FIG. 14, four secondary connection contacts 11021b are arranged in a 2×2 rectangular array. Correspondingly, as shown in FIG. 16, the number of the primary connection contacts 90122 mated with the secondary connection contacts 11021b in the mounting slot 9012 is the same as the number of the secondary connection contacts 11021b. The primary connection contacts 90122 form a primary connection contact array, and the shape of the primary connection contact array is the same as that of the secondary connection contact array. Optionally, the plurality of secondary connection contacts 11021b may include at least one power supply contact and at least one communication contact, such that the communication connection between the handheld gimbal camera 9 and the controller 500 of the handheld apparatus 1, and/or power supply to the handheld apparatus 1 from the handheld gimbal camera 9, and/or power supply and control of the handheld apparatus 1 from the handheld gimbal camera 9 may be achieved through mating the primary connection contacts 90122 with the secondary connection contacts 11021b. The power supply contact includes a positive contact and a negative contact, to form a power supply loop.

As shown in FIG. 14, in some embodiments, the convex platform 11021 of the fixing frame 110 is further provided with secondary detection contacts 11021a. Correspondingly, as shown in FIG. 16, the mounting slot 9012 of the handheld gimbal camera 9 is also provided with primary detection contacts 90121 which may be mated with the secondary detection contact 11021a to detect the assembly state of the handheld gimbal camera 9 and the handheld apparatus 1. In some embodiments, the convex platform 11021 may include a plurality of secondary detection contacts 11021a, and the plurality of secondary detection contacts 11021a may form a circular or rectangular secondary detection contact array. Correspondingly, the primary detection contacts 90121 at the mounting slot 9012 for mating with the secondary detection contacts 11021a also may include a plurality of primary detection contacts 90121, and these primary detection contacts 90122 may be also arranged in a circular or rectangular shape substantially consistent with the shape of the secondary detection contact array. In some embodiments, a secondary detection area may be used instead of the above secondary detection contacts 11021a.

In some embodiments, when the handheld gimbal camera 9 needs to be mounted at the handheld apparatus 1, the handheld gimbal camera 9 may be inserted through the opening 1103 of the handheld apparatus 1, such that the convex platform 11021 in the opening 1103 may extend into the handheld apparatus 1. When the primary detection contacts 90121 detect the secondary detection area or the secondary detection contacts 11021a, it may be determined that the handheld gimbal camera 9 has been correctly mounted to the handheld apparatus 1. Correspondingly, one of the handheld gimbal camera 9 and the handheld apparatus 1 may supply power to another, or control another to execute one or more instructions, through the electrical connection between the primary connection contacts 90122 and the secondary connection contacts 11021b. For example, the handheld gimbal camera 9 may supply power to the controller 500 of the handheld apparatus 1 to avoid the increase in weight caused by the need to mount a battery at the handheld apparatus 1. Further, multiple instructions may be sent to the handheld gimbal camera 9 to perform corresponding actions, for example, to control the camera mounted at the handheld gimbal camera 9 to take pictures and video. In some embodiments, the plurality of primary detection contacts 90121 is provided. Correspondingly, when a preset number of primary detection contacts 90121 or a portion of the plurality of primary detection contacts 90121 in a preset position detects the secondary detection area or the secondary detection contacts 11021a corresponding to these primary detection contacts 90121, it is determined that the handheld gimbal camera 9 and the handheld apparatus 1 have been correctly assembled together. As such, the accuracy of detection can be improved.

The specific forms of the primary connection contacts 90122, the secondary connection contacts 11021b, the primary detection contacts 90121, the secondary detection contacts 11021a, and the secondary detection area are not limited in the present disclosure, and may be any proper form, such as elastic metal contacts or springs.

Further, as shown in FIG. 14, a positioning groove 11021c is formed in the convex platform 11021. Correspondingly, as shown in FIG. 16, a retractable positioning block 136 is provided in the mounting groove 9012 of the handheld gimbal camera 9 to cooperate with the positioning groove 11021c of the convex platform 11021. Therefore, when the handheld gimbal camera 9 is mounted in the opening 1103 of the fixing frame 110, the retractable positioning block 136 may be inserted into the positioning groove 11021c of the convex platform 11021, to limit the position of the handheld gimbal camera 9 and prevent relative movement of the handheld gimbal camera 9 and the handheld apparatus 1 in the lateral direction. Correspondingly, the handheld gimbal camera 9 may be prevented from falling from the handheld apparatus 1. In some embodiments, the retractable positioning block 90123 may be an elastic positioning pin or other similar structures.

Further, as shown in FIG. 14, protrusions 11021d are provided at opposite sides of the top surface of the convex platform 11021. Correspondingly, as showing in FIG. 16, sliding grooves 90124 are provided in the mounting groove 9012 of the handheld gimbal camera 9 for mating with the convex platform 11021. Therefore, when the handheld gimbal camera 9 is mounted in the opening 1103 of the fixing frame 110, the sliding grooves 90124 of the handheld gimbal camera 9 may slide along the extension direction of the protrusions 11021d, facilitating the mounting of the handheld gimbal camera 9. Further, a cooperating structure of the sliding grooves 90124 and the protrusions 11021d may also restrict the handheld gimbal camera 9 from moving in the oblique direction upward and downward as shown in FIG. 1 relative to the handheld apparatus 1, to prevent it from falling. In some other embodiments, only one protrusion 11021d may be provided at the convex platform 11021. Correspondingly, only one sliding groove 90124 may be provided in the mounting groove 9012 of the handheld gimbal camera 9, such that the sliding groove 90124 may mate with the protrusion 11021d of the convex platform 11021. In some embodiments, the first sliding structure and the second sliding structure that are respectively provided in the mounting groove 9012 and the convex platform 11021 are not limited to the sliding grooves 90124 and the protrusions 11021d. The first and second sliding structures may be other sliding structures, including but not limited to, balls, guides, and rollers.

Optionally, as shown in FIG. 14, the positioning grooves 11021c may be provided between the secondary connection contact 11021b and the secondary detection contacts 11021a. Further, the secondary connection contacts 11021b may be closer to the inner wall of the opening 1103 than the secondary detection contacts 11021a. In some embodiments, the positions of the secondary connection contacts 11021b, the positioning grooves 11021c, and the secondary detection contacts 11021a may be configured according to actual needs, and are not limited to the case where all three are disposed at the convex platform 11021 formed in the opening 1103. For example, in some embodiments, the positioning grooves 11021c may be directly formed at the inner wall of the opening 1103.

For description purposes only, the embodiments where the mobile electronic device mounted at the fixed frame 110 of the handheld apparatus 1 is the handheld gimbal camera 9 are used as examples to illustrate the present disclosure, and should not limit the scopes of the present disclosure. In various embodiments, the mobile electronic device may also be another suitable device, including a camera. The above embodiments where the opening 1103 formed by the first buckle member 1101 and the second buckle member 1102 is used to hold the mobile electronic device such as a handheld gimbal camera 9 or a camera are used as examples to illustrate the present disclosure, and should not limit the scope of the present disclosure. In some other embodiment, another suitable structure without the opening 1103 may also be used as the fixing frame 110 to mount the mobile electronic device including the handheld gimbal camera 9 and the camera.

The photographing device provided in the present disclosure may realize quick disassembly and electrical connection of the mobile electronic device by providing the secondary connection contacts 11021a at the fixed frame 110 to be mated with the mobile electronic device such as a handheld gimbal camera 9. Further, the photographing device may have less structures. Therefore, the volume and weight of the photographing device may be reduced, the convenience of users may be improved.

The present disclosure provides a fixing frame and a photographing device based on the above embodiments. In some embodiments, the fixing frame may be connected to mobile electronic devices with different types of ports by changes different connection devices. Further, in some embodiments, the connection device of the fixing frame may be mounted at the main body of the fixing frame in a front or reverse direction. The connection with the mobile electronic devices and the storage of the connector may be facilitated, to prevent the connector from loss.

As shown in FIG. 17, in some embodiments, the photographing device includes: a handheld apparatus 1 and a mobile electronic device mounted at a fixing frame 110 of the handheld apparatus 1. The structure of the handheld apparatus 1 except for the electrical connection mechanism is similar to the above embodiments. The details may be referred to the above description, and will not be repeated here. The mobile electronic device may include a mobile phone, a camera, or a tablet computer. In some embodiments, the mobile electronic device may be a gimbal, at which other portable electronic devices, such as a mobile phone or a camera, may be mounted.

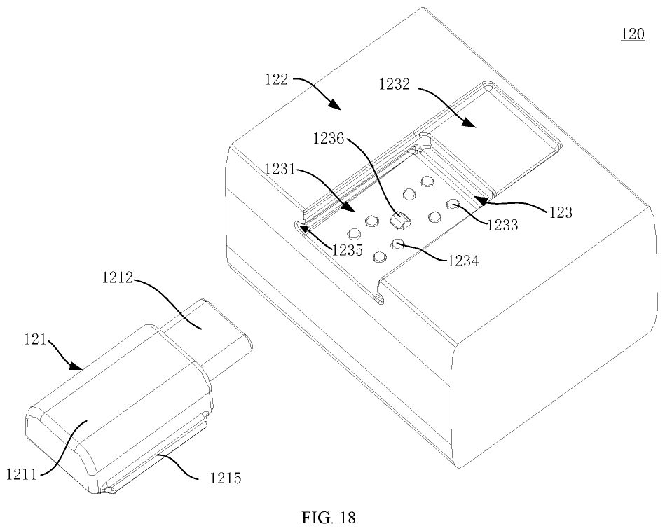

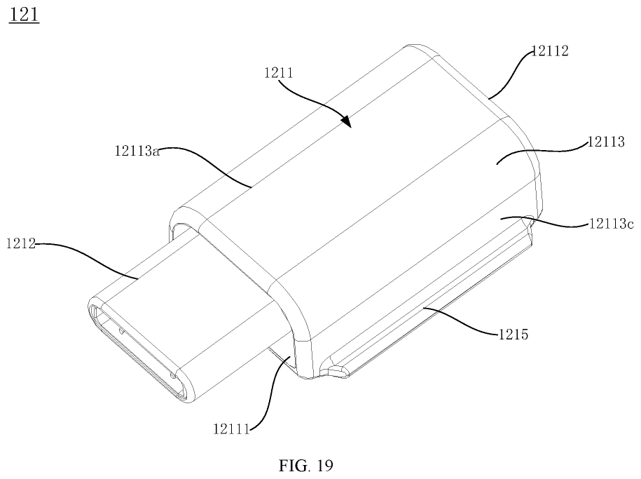

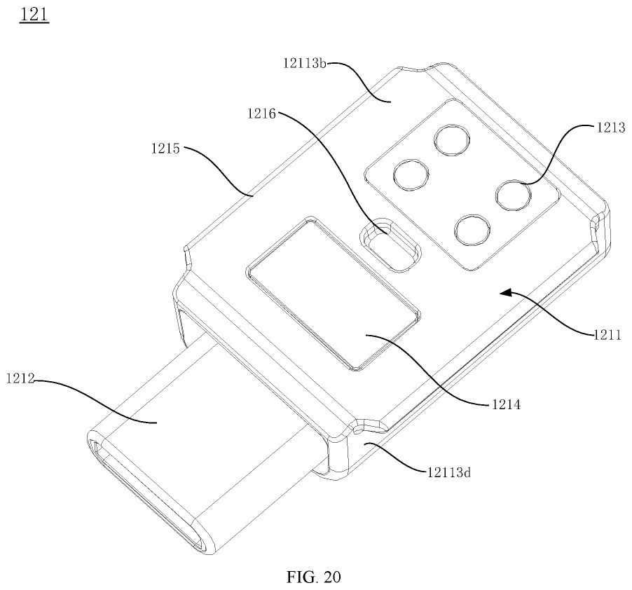

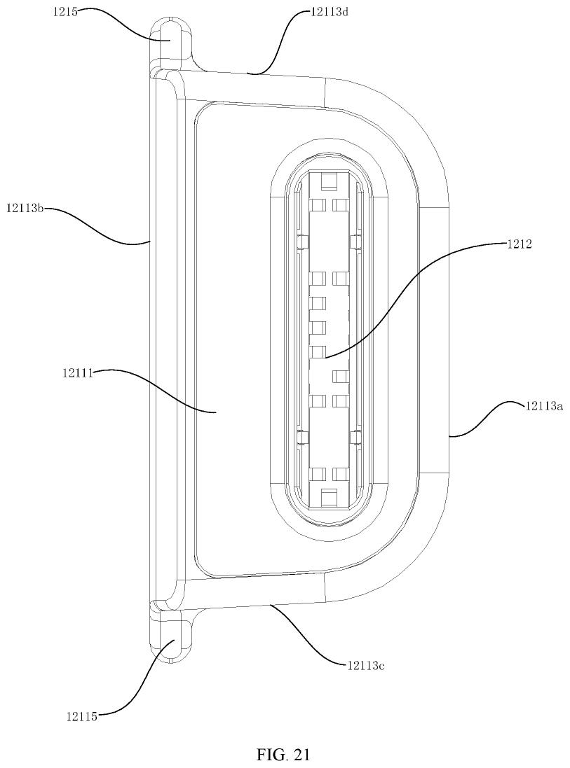

FIG. 17 illustrates a partial structural diagram of the fixing frame 120. FIG. 18 is an exploded view of the fixing frame 120 shown in FIG. 17. FIG. 19 and FIG. 20 are structural diagrams of the connection device in FIG. 17 from different view angles. FIG. 21 is a left view of the connection device shown in FIG. 20.

As shown in FIG. 17, the fixing frame 120 in some embodiments includes a connection device 121 and a main body 122 with a mounting groove 123. As shown in FIG. 21, the connection device 121 includes a housing 1211 detachably mounted in the mounting groove 123 opened in the main body 122, and a connector 1212 for mating with the port of the mobile electronic device and mounted at a front wall 12111 of the housing 1211. As shown in FIG. 18 to FIG. 21, at least one side wall 12113 between the front wall 12111 and the rear wall 12112 of the housing 1211 is also provided with secondary connection contacts 1213 for connecting with primary connection contacts 1233 provided in the mounting groove 123. The secondary connection contacts 1213 are also electrically connected to the connector 1212 mounted at the front wall 12111.

In some embodiments, the connection device 121 may be detachably mounted in the mounting groove 123 opened in the main body 122 of the fixing frame 120, and may be electrically connected with the main body 122 through contacts. Therefore, no connection wire may be required. Further, the connection devices 121 with different connectors 1212 may be changed conveniently by removing the connectors 121, to achieve the communication connection with mobile electronic devices with different interfaces.

Specifically, in some embodiments, the housing 1211 of the connection device 121 may have a shape similar to a rectangular parallelepiped or a cylinder. When the housing 1211 has the shape of a polyhedron, a smooth transition may be made between two adjacent surfaces. For example, as shown in FIG. 19 to FIG. 21, the housing 1211 of this embodiment includes: a front wall 12111 (the lower left side in FIG. 19), a rear wall 12112 (the upper right side in FIG. 19), and four side walls 12113a, 12113b, 12113c, and 12113d between the front wall 12111 and the rear wall 12112. A smooth transition is formed between the front wall 12111 and the side wall 12113, between the four side walls 12113a, 12113b, 12113c, and 12113d, and between the rear wall 12112 and the side walls 12113, as shown in FIG. 19 and FIG. 20.

As shown in FIG. 19 and FIG. 20, in some embodiments, an opening is also be opened at the front wall 12111, such that the connector 1212 may be inserted into the housing 1211 from the opening. Therefore, the connector 1212 may be connected to the electrical connection piece (for example, a circuit board, etc.) at the housing 1211 to be indirectly connected with the following secondary connection contacts 1213. In some embodiments, the connector 1212 may also be electrically connected to the following secondary connection contacts 1213 directly or through a connection wire after being inserted into the housing 1211. In some embodiments, the size of the opening opened in the front wall 12111 may be designed according to actual needs. In addition, the electrical connection piece mounted in the housing 1211 may be any one of a PCB board, an FPC board, or a PCB board and an FPC board that are welded together. The connector 1212 in some embodiments may be any one of a USB connector, a Type-c connector, or a Micro-connector.

In some embodiments, the side wall 12113 may include an upper cover and a lower cover that may cooperate together to form an accommodation space that may accommodate the above circuit board, connection wires and other components. In some other embodiments, the side wall 12113 may also be selectively designed as a structure including an upper cover and a lower plate, such that the accommodating space for accommodating other components may also be formed when the upper cover and the lower plate are combined together. For the convenience of assembly, other parts of the housing 1211 except the side wall 12113 provided with the secondary connection contacts 1213 may be formed into an integrated piece by molding or other integral molding. For example, when the side wall 12113 includes an upper cover and the secondary connection contacts 1213 are disposed at the lower board, the front wall 12111, the rear wall 12112 and the upper cover may be integrated into one piece. Therefore, during assembly, the circuit board, connection wires, etc. may be mounted at the lower board first; and then the upper cover formed integrally with the front wall 12111 and the rear wall 12112 may be closed to the lower plate to complete the mounting of the connection device 121.

Specifically, as shown in FIG. 19 to FIG. 21, the side wall 12113 includes an upper side wall 12113a, a lower side wall 12113b, and a left side wall 12113d and a right side wall 12113c located between the upper side wall 12113a and the lower side wall 12113b. The above secondary connection contacts 1213 may be provided at any one of the upper side wall 12113a, the lower side wall 12113b, the left side wall 12113d, or the right side wall 12113c. In some other embodiments, the secondary connection contacts 1213 may also be provided at multiple of the upper side wall 12113a, the lower side wall 12113b, the left side wall 12113d, or the right side wall 12113c, to improve the reliability of the electrical connection. In some embodiments, the primary connection contacts 1233 may be disposed at the surface of the mounting groove 123 that contacts the secondary connection contacts 1213. For example, when the secondary connection contacts 1213 are disposed at the lower side wall 12113b, the primary connection contacts 1233 may be disposed at the lower surface 123b of the mounting groove 123. When the secondary connection contacts 1213 are disposed at the left side wall 12113d or the right side wall 12113c, the primary connection contacts 1233 may be disposed at the left side 123d or the right side 123c of the mounting groove 123.

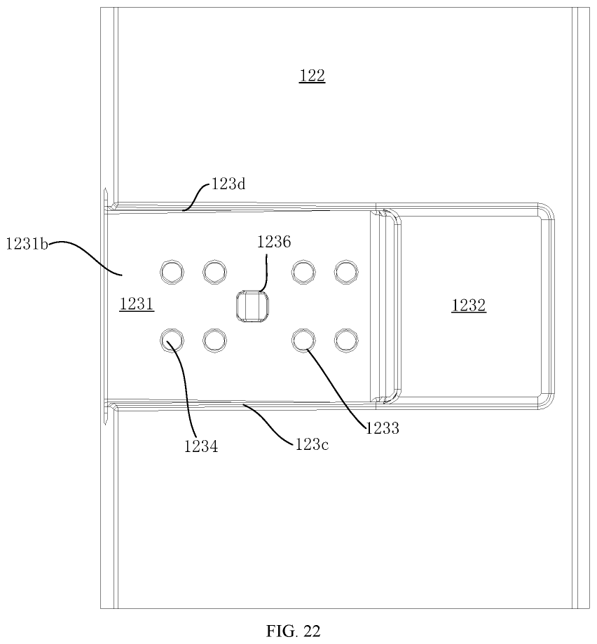

In some embodiments, as shown in FIG. 20, the secondary connection contacts 1213 includes a plurality of secondary connection contacts 1213 forming a circular or rectangular secondary connection contact array, to improve reliability of electrical connection between the primary connection contacts 1233 and the secondary connection contacts 1213. For example, in some embodiments shown in FIG. 20, four secondary connection contacts 1213 are arranged in a 2×2 rectangular array. Correspondingly, the number of the primary connection contacts 1233 mated with the secondary connection contacts 1213 in the mounting groove 123 is the same as the number of the secondary connection contacts 1213. The primary connection contacts 1233 form a primary connection contact array, and the shape of the primary connection contact array is the same as that of the secondary connection contact array, as shown in the top view of the main body 122 in FIG. 18 and FIG. 22. In some embodiments, the plurality of secondary connection contacts 1213 may include at least one power supply contact and at least one communication contact, such that the communication connection between the mobile electronic device and the handheld apparatus 1, and/or power supply to the handheld apparatus 1 from the mobile electronic device, and/or power supply and control of the handheld apparatus 1 from the mobile electronic device may be achieved through mating the primary connection contacts 1233 with the secondary connection contacts 1213. The power supply contact in some embodiments includes a positive contact and a negative contact, to form a power supply loop.

As shown in FIG. 20, in some embodiments, a secondary detection area 1214 is also provided at the side wall 12113 of the housing 1211, to mate with the primary detection contacts 1234 provided in the mounting groove 123 for detecting a mounting state of the connection device 121 when the connection device 121 is mounted into the mounting groove 123. In some embodiments, similar to the secondary connection contacts 1213, the secondary detection area 1214 may also be provided at one or more of the upper side wall 12113a, the lower side wall 12113b, the left side wall 12113d, and the right side wall 12113c. Similar to the primary connection contacts 1233, the primary detection contacts 133 mated with the secondary detection area 1214 may be also arranged at the surface of the mounting groove 123 that is directly opposite to the secondary detection area 1214. In some embodiments, the secondary detection area 1214 may be a rectangle as shown in FIG. 20 or may be a circle or other shapes.

In some other embodiments, the secondary detection contacts may be used to replace the secondary detection area 1214. In some embodiments, a plurality of secondary detection contacts may be arranged at the side wall 12113, and the plurality of secondary detection contacts may form a circular or rectangular secondary detection contact array.

Correspondingly, the primary detection contacts 1234 arranged in the mounting groove 123 for mating with the secondary detection area or the secondary detection contacts may include a plurality of primary detection contacts. The plurality of primary detection contacts 1234 may be arranged into a circle or a rectangular roughly same as the shape of the secondary detection area 1214 or the secondary detection contact array.

In some embodiments, when the connection device 121 needs to be mounted to the main body 122 for mating with the mobile electronic device, the connection device 121 may be inserted into the mounting groove 123. When the primary detection contacts 1234 detects the secondary detection area 1214 or the secondary detection contacts, it may be determined that the connection device 121 has been correctly connected to the main body 122. Further, through the electrical connection between the primary connection contacts 1233 and the secondary connection contacts 1213, the main body 122 may supply power to the mobile electronic device connected to the connector 1212 of the connection device 121, or control the mobile electronic device to execute one or more instructions, or the mobile electronic device may send one or more executable instructions to the fixing frame 120 to control the operation of the mobile electronic device, or the mobile electronic device may also supply power to the fixed frame 120. In some embodiments where there are multiple primary detection contacts 1234, when the preset number of the primary detection contacts 1234 or the primary detection contacts 1234 at a preset position all detect the secondary detection area 1214 or the secondary detection contacts corresponding to these primary detection contacts 1234, it may be determined that the connection device 121 has been correctly connected to the main body 122 to improve the accuracy of detection.

The specific forms of the primary connection contacts 1233, the secondary connection contacts 1213, the primary detection contacts 1234, the secondary detection contacts, and the secondary detection area 1214 are not limited in the present disclosure, and may be any proper technical forms, such as elastic metal contacts or springs.

In some embodiments shown in FIG. 20, the secondary connection contact array and the secondary detection area 1214 may all be arranged at the lower side wall 12113b of the housing 1211. Further, the secondary detection area 1214 and the secondary connection contact array may be arranged at intervals along the length of the connection device 121. That is, the secondary detection area 1214 and the secondary connection contact array may be arranged sequentially along the direction away from the connector 1212. In other words, the secondary detection area 1214 or the secondary detection contact array may be arranged at a position close to the connector 1212, and the secondary connection contact 1213 array may be arranged at a position far from the connector 1212. In some embodiment, similarly, the secondary detection area 1214 may be replaced by secondary detection contacts. In some other embodiments, the secondary detection area 1214 or the secondary detection contact array may be arranged at a position away from the connector 1212, and the secondary connection contact array may be arranged at a position close to the connector 1212. The present disclosure does not exclude the arrangement of the secondary connection contact 1213 array and the secondary detection area 1214 at the upper side wall 12113a, the left side wall 12113d, or the right side wall 12113c. In these alternative structures, the secondary detection area 1214 may also be replaced by the secondary detection contact array.

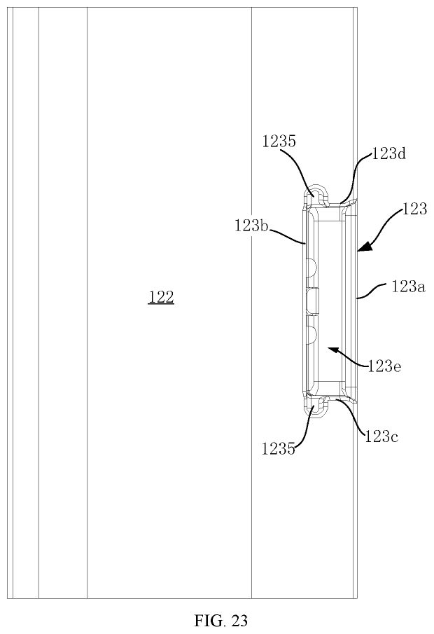

As shown in FIG. 19 to FIG. 21 and a partial left view of the main body 122 shown in FIG. 23, sliding grooves 1235 are formed at the left side 123d and right side 123c of the mounting groove 123. A protrusion 1215 is formed at each of the left side wall 12113d and the right side wall 12113c of the housing 1211. Each protrusion 1215 is matched with a corresponding sliding groove 1235. Through the two protrusions 1215 extending along the length direction of the connection device 121 at the left side wall 12113d and the right side wall 12113c, the two protrusions 1215 may be slid into the sliding grooves 1235 on both sides of the mounting groove 123 when the connection device 121 is mounted. Further, the sliding groove 1235 may have upper and lower limit function, and the connection device 121 may not move in the vertical direction, to prevent the connection device 121 from falling from the mounting groove 123. In some other embodiments, only one protrusion 1215 may be provided at one of the left side wall 12113d or the right side wall 12113c, or a protrusion 1215 may also be provided at the upper side wall 12113a or the lower side wall 12113b. In some embodiments, one protrusion 1215 may also be provided at the upper side wall 12113a or the lower side wall 12113b. Correspondingly, the sliding grooves 1235 provided in the mounting groove 123 and matched with the protrusion 1215 may also be adjusted to the lower surface 123b or the upper surface of the mounting groove 123 accordingly. In some embodiments, the first sliding structure and the second sliding structure that are respectively provided in the mounting groove 123 and at the side wall 12113 of the housing 1211 are not limited to the sliding grooves 1235 and the protrusion 1215, and may be other sliding structures including but not limited to balls, raceways, or rollers.

As shown in FIG. 20 and FIG. 22, a retractable positioning block 136 is disposed at the lower surface 123b of the mounting groove 123, and a positioning groove 1216 is formed at the lower side wall 12113b of the housing 1211 for matching the retractable positioning block 136. Therefore, when the connection device 121 is mounted into the mounting groove 123 of the main body 122, the retractable positioning block 136 may be inserted into the positioning groove 1216 of the lower side wall 12113b of the housing 1211, to limit the position of the connection device 121 and prevent the connection device 121 from moving in the lateral direction. Further, the connection device 121 may be also prevented from falling from the main body 122. In some other embodiments, the positioning groove 1216 may also be disposed at the upper side wall 12113a, the left side wall 12113d, or the right side wall 12113c. Correspondingly, the retractable positioning block 1236 matched with the positioning groove 1216 may be also correspondingly disposed at the upper surface, the left side 123d or the right side 123c of the mounting groove 123. In some embodiments, the retractable positioning block 1236 may be an elastic positioning pin or other similar structures.

In some other embodiments, the above cooperating retractable positioning block 1236 and positioning groove 1216 may also be replaced by other cooperating first positioning structure and second positioning structure of other suitable forms, including but not limited to snap ring and retaining ring, claw, or other structures. For example, an elastic positioning pin may be provided at the housing 1211, and a through hole matching the elastic positioning pin may be opened at the main body 122. The through hole may be connected to the mounting groove 123, and the elastic positioning pin may penetrate into the through hole and extend out of the main body 122. Therefore, when the connection device 121 is mounted in the mounting groove 123, the positioning function may be achieved by the cooperation of the elastic positioning pin and the through hole. When the connection device 121 needs to be removed, the elastic positioning pin may be unlocked by disengaging it from the through hole, such that the connection device 121 may be taken out from the mounting groove 123.

In some embodiments, the secondary detection area 1214, the positioning groove 1216, and the secondary connection contacts 1213 may be arranged at the lower side wall 12113b of the housing 1211 as shown in FIG. 20, and arranged in sequence along the length direction of the connection device 121. For example, the secondary detection area 1214, the positioning groove 1216, and the secondary connection contacts 1213 may be arranged in sequence along the direction away from the connector 1212 as shown in FIG. 20. Similarly, in some embodiments, the secondary detection area 1214 described above may be replaced by secondary detection contacts. In some other embodiments, the positioning groove 1216, the secondary connection contacts 1213, and the secondary detection area 1214 (or the secondary detection contacts) may not be provided at the same side wall of the housing 1211, or only two of them may be disposed at the same side wall of the housing 1211. For example, the positioning groove 1216 and the secondary connection contacts 1213 may be provided at the same side wall 12113 of the housing 1211, and the secondary detection area 1214 or the secondary detection contacts may be provided at a different side wall 12113. For example, the positioning groove 1216 and the secondary connection contacts 1213 may be provided at the lower side wall 12113b, and the secondary detection area 1214 or the secondary detection contacts may be provided at the left side wall 12113d or the right side wall 12113c.

In some embodiments, to facilitate the release of the positioning between the positioning groove 1216 and the retractable positioning block 1236, the positioning groove 1216 may penetrate the entire housing 1211 to form a positioning through hole, and an elastic pressing part may be provided in the positioning through hole. Therefore, when the connection device 121 needs to be detached from the mounting groove 123, the retractable positioning block 1236 that extends into the positioning through hole may be compressed by pressing the elastic pressing part to release its blocking effect on the connection device 121. Furthermore, the connection device 121 may be easily taken out of the mounting groove 123. As shown in FIG. 20, the positioning hole penetrates the upper side wall 12113a and the lower side wall 12113b of the housing 1211, and the retractable positioning block 1236 is disposed at the lower surface 123b of the mounting groove 123. An elastic pressing part is provided in the positioning hole. The elastic pressing part may protrude outside the housing 1211, such as protrude from the upper side wall 12113a of the housing 1211.

As shown in FIG. 17, FIG. 18, FIG. 22 and FIG. 23, the mounting groove 123 of the main body 122 is opened at the top of the main body 122, thereby forming a shape including a front opening 123e and an upper opening 123a. That is, in some embodiments, the mounting groove includes: a front opening 123e, a rear surface opposite to the front opening 123e, an upper opening 123a located between the front opening 123e and the rear surface, a lower surface 123b, a left side 123d, and a right side 123c. Correspondingly, when the above elastic pressing part is mounted in the positioning through hole of the connection device 121 and the connection device 121 is mounted at the main body 122, the elastic pressing part may protrude from the opening surface of the upper opening 123a to facilitate the user's press. In some embodiments, the size of the upper opening 123a of the mounting groove 123 may be designed according to actual needs. It may be understood that in the main body with the structure of this embodiment, the primary connection contacts 1233, the primary detection contacts 1234, the retractable positioning block 1236 and the sliding groove 1235 provided in the mounting groove 123 may be provided at one or more of the left side 123d, the right side 123c, and the lower surface 123b of the mounting groove 123. For example, in some embodiments, the primary connection contacts 1233, the primary detection contacts 1234, the retractable positioning block 1236 and the sliding groove 1235 may be provided at the lower surface 123b as shown in FIG. 22.

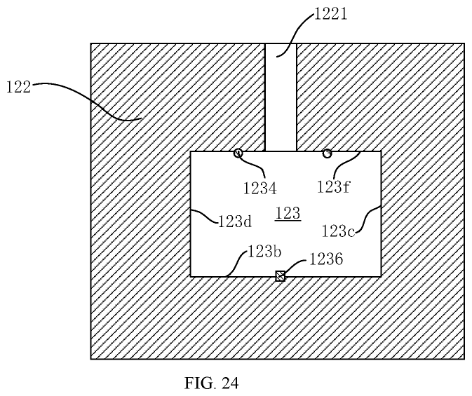

FIG. 24 illustrates a partial cross-sectional view of another main body provided by various embodiments of the present disclosure. As shown in FIG. 24, the mounting groove 123 is opened between the top and bottom of the main body 122. That is, the mounting groove 123 in this example includes a front opening 123e, a rear surface opposite to the front opening 123e, an upper surface 123f, a lower surface 123b, a left side 123d, and a right side 123c located between the front opening 123e and the rear surface. Further, one or both of the primary connection contacts 1233 and the primary detection contacts 1234 provided in the mounting groove 123 may be both provided at the upper surface 123f. In some other embodiments, the primary connection contacts 1233 and the primary detection contacts 1234 may be provided at one or more of the lower surface 123b, the left side 123d, and the right side 123c of the mounting groove. Optionally, for the convenience of unlocking, in some embodiments, the retractable positioning block 1236 may be provided at the lower surface 123b, and an escape hole 1221 opposite to the retractable positioning block 1236 may be disposed at the upper surface 123f, to make the connection device 121 more flexible. The pressing part may pass through the escape hole 1221 to facilitate pressing operation to unlock the connection between the connection device 121 and the main body 122. In practical applications, when the mounting groove 123 also has only one opening surface, a position or shape of the opening surface may be adjusted accordingly as needed. For example, in some embodiments, all of or a part of the upper surface 123f of the mounting groove 123 in contact with the elastic pressing part may be made of an elastic material such as silica gel to facilitate the pressing of the elastic pressing part through the upper surface 123f, which is not specifically limited here.

In some embodiments, the connection device 121 may be mounted in the mounting groove 123 in the forward direction and in the reverse direction, to make the storage of the connection device 121 may be more convenient. The connection device 121 may be mounted in the mounting groove 123 in the forward direction as shown in FIG. 17, such that the connector 1212 of the connection device 121 may protrude from the mounting groove 123 to facilitate the mating of the mobile electronic devices. Further, the connection device may also be reversely mounted into the mounting groove 123 as shown in FIG. 18, such that the connector 1212 of the connection device 121 is also received in the mounting groove 123 to avoid that the connector 1212 of the connection device 121 interferes with other objects. Therefore, the connector 1212 may be protected and the mounting and transportation of the fixing frame 120 may be facilitated.

Specifically, to enable the connection device 121 to be mounted in the mounting groove 123 in the forward and reverse directions, as shown in FIGS. 18 and 22, the mounting groove 123 may include a first receiving groove for receiving a housing 1231 of the connection device 121 and a second receiving groove 1232 for receiving the connector 1212 of the connection device 121. The level of the lower surface of the first receiving groove 1231 is lower than the level of the lower surface of the second receiving groove 1232. It may be understood that when the connection device 121 is mounted in the mounting slot 123 in the forward direction, the secondary detection area 1214 or the secondary detection contacts of the connection device 121 may contact the primary detection contacts 1234 in the mounting groove 123, the secondary connection contacts 1213 may contact he primary connection contacts 1233, and the retractable positioning block 1236 in the mounting groove 123 may be clamped into the positioning slot 1216 of the connection device 121. When the connection device 121 is mounted in the mounting groove 123 in the reverse direction, the primary detection contacts 1234 does not contact the secondary detection area 1214 or the secondary detection contacts, and the primary connection contacts 1233 may not contact the secondary detection contacts 113, but the retractable positioning block 1236 in the mounting groove 123 may be inserted into the positioning groove 1216 of the connection device 121.

For description purposes only, the embodiment in FIG. 17 and FIG. 18 where the mounting groove 123 is disposed in the horizontal direction and the primary connection contacts 1233 are disposed at the lower surface 123b of the mounting groove 123 to improve the reliability of the electrical connection, is used as an example to illustrate the present disclosure, and does not limit the scope of the present disclosure. In some other embodiments, the mounting groove 123 may be disposed in the vertical direction or another suitable direction.

In some embodiments, the main body 11 of the fixing frame 120 may be mounted at the top end of the telescopic rod 200 by clamping or screwing, or may be rotatably connected to the top end of the telescopic rod 200 provided by the embodiment 1 through a rotating shaft. The mobile electronic device may be electrically connected to the controller 500 at the handheld member 400 through the connection device 121 and the communication wire 300, such that the controller 500 at the handheld member 4 may control the operation of the mobile electronic device including taking pictures or video. In some embodiments, the mobile electronic device may also be wirelessly connected to the controller 500 at the handheld member 400 via the connection device 121 and a wireless communication circuit electrically connected to the primary connection contacts 1233, to realize data transfer with the controller 500 of the handheld member 400.

In addition, in some embodiments, the mobile electronic device may supply power to the connection device 121 and the controller 500 at the handheld member 400. In some other embodiments, the power supply provided at the handheld member 400 may supply power to the mobile electronic device.

In the photographing device provided in some embodiments, the fixing frame 120 may be configured to include a main body 122 and a connection device 121 connected with the main body 122 through contacts, such that the connection device 121 with different types of connectors may mate with the mobile electronic devices with the same type of interface. Therefore, the types of mobile electronic device that may be mated with that the handheld apparatus 1 may be expanded. Further, by further improving the mounting groove 123 of the main body 122, it may be also possible to store the connection device 121 in the main body 122 when the handheld apparatus 1 is not mated with the mobile electronic device, to prevent the connection device 121 from being lost.

In this disclosure, descriptions with reference to the terms “one embodiment,” “some embodiments,” “exemplary embodiments,” “examples,” “specific examples,” or “some examples” etc., mean that the specific features, structures, materials, or characteristics described in the embodiments or examples are included in at least one embodiment or example of the present disclosure. In this disclosure, the schematic representations of the above terms do not necessarily refer to the same embodiment or example. Moreover, the described specific features, structures, materials, or characteristics may be combined in any one or more embodiments or examples in an appropriate manner.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A handheld apparatus comprising:
a telescopic rod;
a fixing frame mounted at a top end of the telescopic rod and configured to support a mobile electronic device;
a handheld member sleeved at a position close to a bottom end of the telescopic rod, the bottom end of the telescopic rod being configured to move between a first position and a second position relative to the handheld member; and
a support structure foldably mounted at a bottom end of the handheld member and configured to be in a folded state to accommodate the bottom end of the telescopic rod when the telescopic rod is in the first position.

2. The handheld apparatus according to claim 1, wherein a limit structure is formed at an inner wall of the handheld member and an outer wall of the bottom end of the telescopic rod, the limit structure being configured to limit the telescopic rod between the first position and the second position, and including parts that cooperate with each other.

3. The handheld apparatus according to claim 2, wherein the limit structure includes:
a groove at one of the inner wall of the handheld member and the outer wall of the bottom end of the telescopic rod; and
a protrusion block at another one of the inner wall of the handheld member and the outer wall of the bottom end of the telescopic rod, the protrusion block being configured to extend into the groove.

4. The handheld apparatus according to claim 2, wherein the handheld member and the telescopic rod are provided with locking structures configured to cooperate with each other to lock the handheld member and the telescopic rod when the bottom end of the telescopic rod is at to a predetermined position.

5. The handheld apparatus according to claim 4, wherein the locking structures include a friction plate at the inner wall of the handheld member and a friction surface at the telescopic rod configured to cooperate with the friction plate to achieve self-locking.

6. The handheld apparatus according to claim 5, wherein the friction plate includes a first friction plate and a second friction plate disposed at two ends of the limit structure along an axial direction of the telescopic rod.

7. The handheld apparatus according to claim 1, further comprising:
a controller at the handheld member and configured to control the mobile electronic device.

8. The handheld apparatus according to claim 7, further comprising:
a communication wire penetrating through the telescopic rod along an axial direction of the telescopic rod;
wherein:
a first end of the communication wire extends into the handheld member and connected to the controller;
a length of a part of the communication wire extending into the handheld member is reserved with sufficient length variation margin to be adapted to movement of the telescopic rod between the first position and the second position; and
a second end of the communication wire is configured to be connected to the mobile electronic device.

9. The handheld apparatus according to claim 8, further comprising:
a bottom cover sleeved at the bottom end of the telescopic rod;
wherein the first end of the communication wire passes through a gap between the bottom cover and the telescopic rod, and extends into the handheld member.

10. The handheld apparatus to claim 8, wherein a part of the communication wire in the telescopic rod has a spiral shape.

11. The handheld apparatus according to claim 1, wherein the support structure includes a plurality of legs rotatably connected to the handheld member.

12. The handheld apparatus according to claim 11, wherein:
a limit surface is formed at the bottom end of the handheld member; and
the limit surface is configured to abut against the plurality of legs when the plurality of legs rotate with respect to the handheld member to open the support structure, to limit rotation angles of the plurality of legs.

13. The handheld apparatus according to claim 11, wherein:
a recessed part is formed in each of the plurality of legs; and
when the plurality of legs are in the folded state, the recessed parts of the plurality of legs enclose to form an accommodation cavity for accommodating the bottom end of the telescopic rod.

14. The handheld apparatus according to claim 1, wherein the fixing frame is rotatably connected to the top end of the telescopic rod.

15. The handheld apparatus according to claim 1, wherein the fixing frame includes a first buckle member and a second buckle member configured to detachably buckle together to form an opening that is configured to allow the mobile electronic device to pass through.

16. The handheld apparatus according to claim 15, wherein an electrical connection mechanism is formed at an inner wall of the opening and configured to be electrically connected to the mobile electronic device.

17. The handheld apparatus according to claim 16, wherein the electrical connection mechanism includes secondary connection contacts configured to mate with primary connection contacts in a mounting groove of the mobile electronic device.

18. The handheld apparatus according to claim 17, wherein the electrical connection mechanism further includes a secondary detection are or a secondary detection contact configured to mate with a primary detection contact in the mounting groove.

19. The handheld apparatus according to claim 18, wherein:
a first positioning structure is provided in the mounting groove; and
a second positioning structure is disposed at the inner wall of the opening and configured to cooperate with the first positioning structure.

20. A photographing device comprising:
a mobile electronic device; and
a handheld apparatus including:
a telescopic rod;
a fixing frame mounted at a top end of the telescopic rod and configured to support the mobile electronic device;
a handheld member sleeved at a position close to a bottom end of the telescopic rod, the bottom end of the telescopic rod being configured to move between a first position and a second position relative to the handheld member; and
a support structure foldably mounted at a bottom end of the handheld member and configured to be in a folded state to accommodate the bottom end of the telescopic rod when the telescopic rod is in the first position.
